(19) United States
(12) Patent Application Publication
(10) Pub. No.: US 2007/0003224 A1
(43) Pub. Date: Jan. 4, 2007

(54) Screen Management System for Media Player

(76) Inventors: Jason Krikorian, San Mateo, CA (US); Blake Krikorian, San Mateo, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/428,115

(22) Filed: Jun. 30, 2006

Related U.S. Application Data
(60) Provisional application No. 60/696,230, filed on Jun. 30, 2005.

(51) Int. Cl. H04N 7/00

(52) U.S. Cl. 386/95

(57) ABSTRACT

A screen management system for a media player allows a viewing area of the media player to be docked in an area of the screen and undocked from a docked position. When docked, the viewing area can be moved and/or resized so that the viewing area takes up a different portion of the screen. The remaining portion of the screen not used by the docked viewing area is automatically adjusted (e.g., resized or resealed) to accommodate the change. The media player may include controls for controlling a media stream received from a remote source.

### CROSS REFERENCE TO RELATED APPLICATIONS

This application claims the benefit of U.S. Provisional Application No. 60/696,230, filed Jun. 30, 2005, which is incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

This invention relates generally to media players for placeshifting and other streaming media systems, and in particular to screen management systems for providing a graphical interface for a media player on a display screen of a client device.

The personal computer is increasingly becoming a point of media consumption for consumers. While the personal computer was initially focused on productivity tasks, it is more and more being used by consumers for entertainment—e.g., to watch video content and listen to music and other audio content. Naturally, this has resulted in the creation of many media players designed for the personal computer. Media players are software applications that play or stream audio and video. Common examples of these players include the Windows Media Player from Microsoft, and the RealOne player from RealNetworks.

While these applications may do a fine job actually playing the media content, they fall short in addressing the needs of a multi-tasking consumer. Most modern windows-based operating systems support multiple overlapping application windows. While this feature is very useful in multitasking environments, a user typically does not want the window in which a video is played to be obscured by other windows. Specifically, a consumer who wishes to view the media player while using other software applications is often left rearranging the various application windows on the computer screen in an attempt to achieve an optimal layout. The difficulty of this task is compounded as the user opens additional applications or windows, as these must also be arranged to avoid obscuring the media player.

Some previous systems addressed this difficulty with an “always on top” option for the media player window. This option ensures that a media player window always stays visible in front of other windows, but while addressing one problem it introduces some additional problems. For example, the area of the secondary window that obscured by the media player window may become relevant to the user's task. In such a case, the user would be forced to move the media player window to view the content, and then rearrange the layout once more after this is done. This process becomes tedious and can be quite frustrating for the user who wants to perform common tasks—such as checking email while watching a baseball game.

Media players for placeshifting systems encounter these and additional problems as compared to traditional media players. In a placeshifting system, such as the SLINGBOX™ from Sling Media, Inc., a media player client application runs on a client device and receives a media stream from a personal media broadcaster. The personal media broadcaster obtains media content from one or more A/V sources and is often located in the home or at a remote location from the client device. In addition to having a video display, the media player client application includes controls for adjusting content from the personal media broadcaster, such as changing the channel or switching the A/V source being broadcast. Accordingly, these controls and the video display further complicate the screen real estate problem. Moreover, because of the nature of a placeshifting system, a user is more likely to watch the media player of a placeshifting system while performing other tasks on the computer, such as email. This multitasking thus compounds the screen real estate problem more than for traditional media players, which are typically used to watch a particular media item between computing tasks. Accordingly, media players for placeshifting systems require an even more robust screen management system than traditional media players.

### SUMMARY OF THE INVENTION

A screen management system for a media player allows a viewing area of the media player to be docked in an area of the screen reserved for the media player. In some embodiments, the media player can be undocked from a docked position and presented as a traditional window as well. When docked, the viewing area of the media player can be moved and/or resized so that the viewing area takes up a different portion of the screen. The remaining portion of the screen not used by the docked viewing area is automatically adjusted (e.g., resized or resealed) to accommodate the change. The media player may also include controls for controlling a media stream received from a remote source, such as in a placeshifting system. This allows a computer user to enjoy an audio/video experience conveniently while at the same time working with other software applications.

In one embodiment, a personal media broadcasting system comprises a personal media broadcaster and a media player configured to run on a client device. The personal media broadcaster receives an analog or digital media signal from an audio/video source, constructs a media stream from the analog signal, and transmits the media stream over a computer network. Running the media player, the client device communicates with the personal media broadcaster over the computer network to receive the media stream. The client device includes a display that comprises a sidebar for viewing the media stream and a desktop for interacting with other programs on the client device. Accordingly, the client device plays the media stream in the sidebar, allowing a user to interact with other programs via the desktop while viewing the played media stream. The media player also allows a user to resize and/or move the sidebar, or eliminate the sidebar and play the media stream in a window in the desktop. Upon creation, moving, or resizing of the sidebar, the media player scales or otherwise adjusts the desktop to account for the change.

In another embodiment of the invention, a media player is a software application configured to run on a client device, which receives video data and renders the video data into a playable video stream. The media player plays the video stream in a media player window within a screen of the client device, wherein the media player window is within an active area of the screen of the client device. A user can provide a dock command to dock the media player window on the client device. Responsive to the dock command, the media player moves the video stream to a sidebar area of the screen. The sidebar area may be further moved and/or resized as desired by a user. Upon creation or any adjustment of the sidebar area, the active area of the screen—and any content therein—is scaled as needed to adjust for the change to the sidebar.

According to various embodiments, the docked mode for the media player client application enables a user to enjoy an audio/video experience conveniently while at the same time working with other software applications. Many new multimedia-oriented computers have wide screen displays, and many common applications (such as email and word processing programs) do not take full advantage of the extended horizontal space. Accordingly, embodiments of the invention in which a media player is docked on a side of the computer screen make use of this space while minimizing the effect on other applications.

### BRIEF DESCRIPTION OF THE DRAWINGS

FIG. 1 is a schematic drawing of a system for remote viewing of a media stream, including a media player in which embodiments of the invention may be implemented.

FIG. 2 is a screen shot showing a media player not in docked mode, in accordance with an embodiment of the invention.

FIG. 3 is a screen shot showing a media player docked at a right side of the screen, in accordance with an embodiment of the invention.

FIG. 4 is a screen shot showing a media player docked at a left side of the screen, in accordance with an embodiment of the invention.

### DETAILED DESCRIPTION OF THE PREFERRED EMBODIMENTS

Embodiments of the invention provide a screen management system for a media player. The media player can be used in any of a variety of contexts. For example, the media player can be used as a stand alone or traditional media player, playing audio and video clips located on a local or network disk, or streamed via the Internet from some other remote server. The physical components used in the system may depend on the method in which the media content is delivered to one or more consumers of that content. Moreover, media content may be delivered from the source to the destination device through a variety of means, including, but not limited to, over the air via analog or digital RF transmission; IP transmission delivered over a wired network or a wireless network (or a combination) in a unicast or multicast method; wireless or wired networks (which may or may not be IP) dedicated to the delivery of multimedia content; cable, twisted pair, or fiber networks; and satellite transmission.

If delivered over an IP network, the media stream may be converted from analog to digital form if the stream is not already in digital form. This allows for any type of traditionally analog broadcast media to be digitized and delivered to an IP device. Alternatively, digital media may be obtained from a server (e.g., operated by a content provider), a network access server, a network storage device, or another personal computer in a peer-to-peer scenario. The digital media is then sent over a network (such as the Internet, a private WAN, a LAN, a cellular network, or any other network suitable for delivering digital data) to a client device. The client device may be a personal computer, a cellular phone, a PDA, a dedicated set top box that outputs to a television or monitor, or any other type of device that can receive and render the digital media data. The method for delivery and consumption of the content may also vary broadly, including, but not limited to, traditional linear programming, video on demand, pay-per-view (in set intervals), and “store and forward” delivery. In store and forward delivery, content may be loaded on or written to a storage device, which then sends the content to the destination device via a data network or any number of other methods, for viewing when available. The store may be centrally managed by a service or content provider, contained within a person's home, or even located within a placeshifting device.

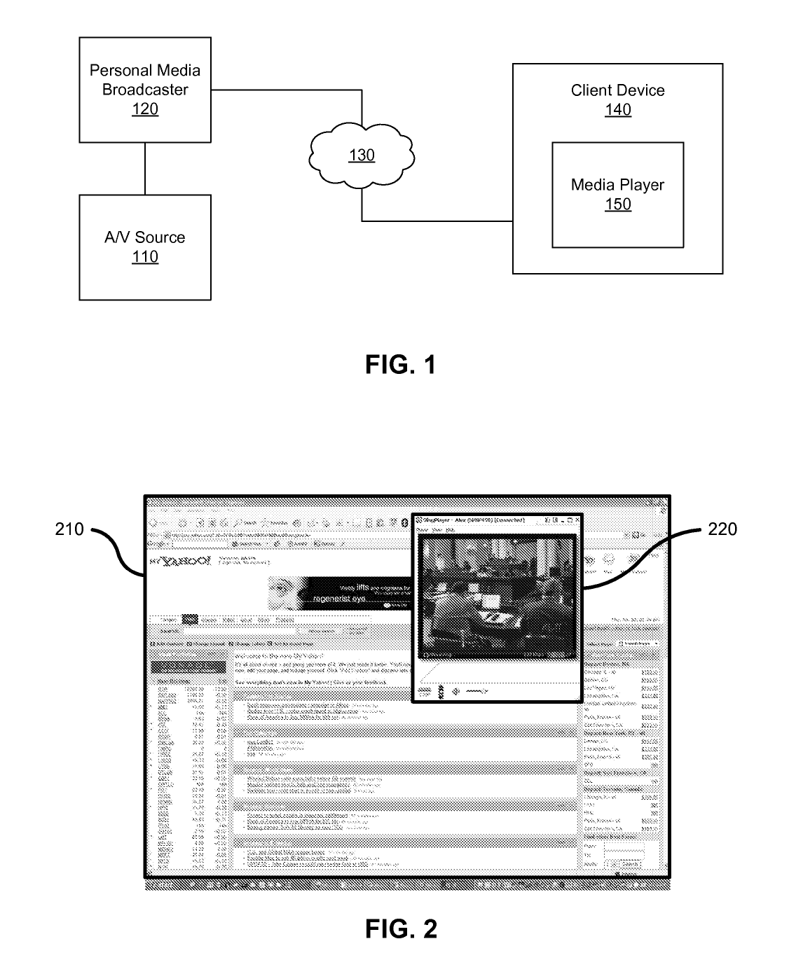

In one particularly useful application of the screen management system, the video content is delivered by a placeshifting system. A placeshifting system, also called a personal media broadcasting system, enables video distribution over a computer network wherein a user can view and control one or more A/V sources over the computer network from a remote location. Embodiments of placeshifting systems are described in U.S. application Ser. No. 11/147,664, entitled “Personal Media Broadcasting System,” filed Jun. 7, 2005, which is incorporated by reference in its entirety. FIG. 1 illustrates a placeshifting system, in which a media player 150 is used in connection with a personal media broadcaster 120.

In a placeshifting system, a personal media broadcaster 120 receives media content from an A/V source 110, which may be any among a variety of types of media source devices (such as DVD players, DVRs, television tuners, cable set-top boxes, and the like). Alternatively, the personal media broadcaster 120 may receive a signal from a media broadcaster and include an integrated tuner (such as a cable set-top box) for processing the received signal. The personal media broadcaster 120 then digitizes and compresses the content, processes the compressed content into a form transmittable over a network, and streams the compressed media content over a computer network 130 to a client device 140.

A media player 150 is a software application that runs on the client device 150, which may be any appropriate type of device capable of viewing the media. The media player 150 may allow a user to issue control commands (e.g., “channel up”) from the client device 140 to the personal media broadcaster 120. Responsive to the control commands, the personal media broadcaster 120 causes the A/V source 110 to execute the command, thereby adjusting the content delivered to the personal media broadcaster 120 and, ultimately, to the client device 140. The personal media broadcaster 120 and the media player 150 may employ various techniques for buffering, transmitting, and viewing the content to improve the user's experience.

In the various system architectures in which the video content is obtained, the associated client device 140 includes a display screen for viewing the video content. In the case where the client device 130 is a general purpose multipurpose computing device, the display screen will commonly be used for applications in addition to viewing the video content. Accordingly, its display screen will be used in part for the video content and in part for the user interface of other applications.

FIG. 2 is a screen shot of the display for a computing device in which the media player 150 and one or more other applications are running. The display screen comprises an active area 210, in which the user may interact with any of a variety of applications that can run on the client device 140. For a personal computer, this active area 210 is often referred to as the desktop, or includes the desktop, and it may contain any number of icons that represent object accessible to the personal computer and windows displaying the content of processes running on the computer, among other items. In one embodiment, the media player 150 is also accessible via a media player window 220 that may exist within the active area 210 of the display. The media player window may include a display portion in which the video content received from the client device 140 may be viewed and a control portion in which the user may issue commands to adjust the received video content.

FIG. 2 illustrates an embodiment of the media player 150 while in an undocked mode. In one embodiment, the client device 140 is configured to receive commands from a user to dock the media player 150. Responsive to such a command, the client device 140 puts the media player 150 in a docked mode. In this way, the media player 150 can be put into either one of a set of modes, including “docked” and “undocked” modes. In one embodiment, when docked, the media player 150 can later be undocked. Alternatively, the media player 150 may be presented always in a docked mode.

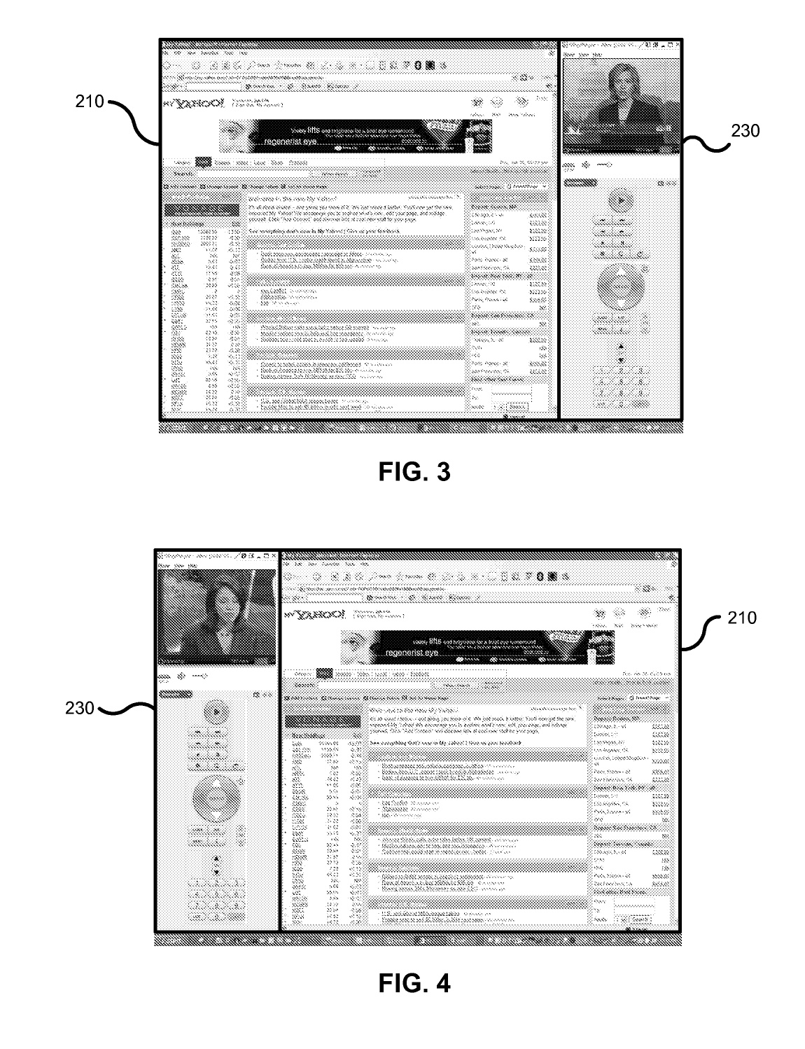

FIG. 3 is a screen shot of the media player 150 of FIG. 2 in a docked mode. When the media player 150 is put in the docked mode, the media player window 220 (from FIG. 2) becomes a media player sidebar 230 on a side of the display, as shown in FIG. 3. Like the media player window 220, the media player sidebar 230 may also include user controls for adjusting the video content received from a remote source by the client device 140. As illustrated, the media player sidebar 230 is docked on the right side of the screen; however, the media player sidebar 230 may be docked along any edge of the screen or in any desired portion of the screen. Beneficially, when placed in a docked mode on a side edge of the screen for a widescreen display, the media player 150 uses a portion of the display that is often not used in many types of computing systems. In one embodiment, the media player 150 is placed in a docked mode by dragging its window near an edge of the screen, or by selecting an option manually from the media player window 220.

When the media player 150 is placed in the docked mode, there is no media player window 220 that can overlay on the other icons or other application windows that populate the active area 210. Instead, the media player 150 replaces this window 220 with the new media player sidebar 230 for displaying the video content. In this way, the media player sidebar 230 created is independent from the active area 210 of the client device 140, and a portion of the screen that is occupied by the media player sidebar 230 is essentially reserved for the media player 150. Because the display of the client device 140 is limited, the media player 150 also resizes, rescales, and moves as necessary the active area 210 so that all other icons, windows, and other interface elements are shifted to make room for placement of the media player sidebar 230.

The client device 140 and any applications or processes running thereon are made aware that the media player sidebar 230 portion of the screen is not available. Accordingly, and the other applications are placed in the remainder of the screen, the newly sized active area 210, which is essentially a resized desktop of the client device 140. Other applications running on the client device 140 may also take note of the reserved media player sidebar 230 space when they attempt to resize. For example, when a user normally gives an application a command to “maximize,” it resizes to take up the maximum resolution of the display. When the media player 150 is in the docked mode, an application that is maximized will take up all of the active area 210 that is not currently occupied by media player. Advantageously, the display is effectively partitioned so that tasks performed in the active area 210 of the display are separate from video played in the media player sidebar 230 portion of the display.

In one embodiment, the media player sidebar 230 can also be increased or decreased in size, e.g., by clicking on the edge of the media player sidebar 230 and dragging it to the desired size. In one embodiment, after a resizing of the media player sidebar 230, the content within the active area 210 is automatically resealed to account for the increase or decrease in available screen real estate due to the adjustment of the media player sidebar 230.

In addition to resizing, in one embodiment, the media player sidebar 230 may also be resituated from one portion of the display screen to another. For example, when docked on a right edge of the display screen, the media player sidebar 230 can be moved to the left side of the display screen. When the media player sidebar 230 is moved, the active area 210 of the display screen, including the content therein, is moved accordingly to account for the newly available screed space. FIG. 4 is a screen shot of the display screen of FIG. 3 after the media player sidebar 230 is moved from a docked position on the right edge of the screen to a docked position on the left edge of the display screen. As the screen show shows, the content within the active area 210 automatically adjusts to this move.

The media player sidebar 230 can be implemented using a variety of techniques, depending on the type of client device 140 on which the media player 150 runs. For a typical person computer, many operating systems provide an application programming interface (API) that allows applications to implement the behavior of the media player sidebar 230. For example, the Microsoft WINDOWS® operating systems support APIs that allow software developers to implement a graphical user interface item called an “application desktop toolbar,” or “appbar.” The application desktop toolbar is a window that is similar to the Microsoft WINDOWS® taskbar, as it can be anchored to an edge of the screen and typically contains buttons that give the user quick access to other applications and windows. The operating system prevents other applications from using the desktop area occupied by an application desktop toolbar.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

Accordingly, the present invention has been described in particular detail with respect to various embodiments, and those of skill in the art will appreciate that the invention may be practiced in other embodiments. Those of skill in the art will appreciate that the particular naming of the components, capitalization of terms, the attributes, data structures, and any other programming or structural aspect are not mandatory or necessarily significant, and the mechanisms that implement the invention or its features may have different names, formats, or protocols. In addition, the particular division of functionality between the various system components described herein is merely exemplary, and not mandatory; functions performed by a single system component may instead be performed by multiple components, and functions performed by multiple components may instead performed by a single component.

Any of the steps, operations, or processes described herein can be performed or implemented with one or more software modules or hardware modules, alone or in combination with other devices. It should further be understood that any portions of the system described in terms of hardware elements may be implemented with software, and that software elements may be implemented with hardware, such as hard-coded into a dedicated circuit. For example, code for performing the methods can be embedded in a hardware device, such as an MP3 player, for example in an ASIC or other custom circuitry. In a hardware embodiment, portions or all of the methods can be performed by analog and/or digital circuitry. In one embodiment, a software module is implemented with a computer program product comprising a computer-readable medium containing computer program code, which can be executed by a computer processor for performing any or all of the steps, operations, or processes described herein.

Some portions of this description describe algorithms and symbolic representations of operations on information. These algorithmic descriptions and representations are the means used by those skilled in the data processing arts to convey the substance of their work to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware or hardware.

In addition, the terms used to describe various quantities, data values, and computations are understood to be associated with the appropriate physical quantities and are merely convenient labels applied to these quantities. Unless specifically stated otherwise as apparent from the following discussion, it is appreciated that throughout the description, discussions utilizing terms such as “processing,” “computing,” “calculating,” “determining,” or the like refer to the action and processes of a computer system, or similar electronic computing device, that manipulates and transforms data represented as physical (electronic) quantities within the computer system memories or registers or other such information storage, transmission, or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

What is claimed is:

1. A personal media broadcasting system comprising:
a personal media broadcaster configured to receive a media signal from a media source, construct a network-transmittable media stream from the media signal, and transmit the media stream over a computer network; and
a computer-readable medium containing a media player that comprises computer program code for causing a client device to:
communicate with the personal media broadcaster over the computer network to receive the media stream,
partition a display of the client device into a sidebar for viewing the media stream and an active area for interacting with other programs on the client device, and
play the media stream in the sidebar of the display.

2. The system of claim 1, wherein the sidebar is reserved for the media player so that interacting with other programs on the client device is disallowed within the sidebar.

3. The system of claim 1, wherein the media player further comprises computer program code for causing a client device to eliminate the sidebar and play the media stream in a window in the active area, responsive to a user command.

4. The system of claim 1, wherein the media player further comprises computer program code for causing a client device to resize the sidebar responsive to a user command.

5. The system of claim 4, wherein the media player further comprises computer program code for causing a client device to rescale the active area when the sidebar is resized.

6. The system of claim 1, wherein the media player further comprises computer program code for causing a client device to move the sidebar responsive to a user command.

7. The system of claim 5, wherein the media player further comprises computer program code for causing a client device to adjust the active area when the sidebar is moved.

8. The system of claim 1, wherein the media player further comprises computer program code for receiving a user command to adjust the media stream received from the personal media broadcaster by the client device.

9. The system of claim 1, wherein the client device comprises a personal computer.

10. A computer program product for viewing video on a client device, the computer program product comprising a computer-readable medium containing computer program code for:
receiving video data;
rendering the video data into a playable video stream;
playing the video stream in a media player window within a screen of the client device, wherein the media player window is within an active area of the screen that allows interaction with other applications running on the client device;
receiving a dock command to dock the media player window; and
playing the video stream in a sidebar area of the screen responsive to the dock command, wherein the active area of the screen is scaled to adjust for the sidebar area.

11. The computer program product of claim 10, wherein the computer-readable medium further contains computer program code for:
responsive to the dock command, creating the sidebar area of the screen, reducing the active area of the screen, and resealing the active area screen.

12. The computer program product of claim 10, wherein the active area of the screen comprises interfaces for other applications running on the client device, and the interfaces for the other applications are disallowed within the sidebar area.

13. The computer program product of claim 10, wherein the computer-readable medium further contains computer program code for:
receiving an undock command to undock the media player window;
eliminating the sidebar area on the screen;
enlarging the active area of the screen;
resealing the active area of the screen; and
playing the video stream in the media player window in the active area of the screen.

14. The computer program product of claim 10, wherein the computer-readable medium further contains computer program code for:
receiving a resize command to resize the sidebar area;
resizing the sidebar area according to the resize command;
resizing the active area according to the resized sidebar area; and
resealing the active area of the screen.

15. The computer program product of claim 10, wherein the computer-readable medium further contains computer program code for:
receiving a move command to move the sidebar area to a different portion of the screen;
moving the sidebar area according to the move command; and
adjusting the active area of the screen according to the movement of the sidebar area.

16. The computer program product of claim 10, wherein the video data is received from a remote source, and the computer-readable medium further contains computer program code for:
receiving a user command to adjust the video data received from a remote source; and
sending the user command to the remote source to adjust the video data received therefrom.

17. The computer program product of claim 16, wherein the sidebar area of the screen includes controls for a number of user commands to adjust the video data.

18. The computer program product of claim 10, wherein the active area of the screen is a desktop of a windows-based operating system.

19. The computer program product of claim 10, wherein the sidebar area is a sidebar docked along an edge of the screen.

20. The computer program product of claim 10, wherein the client device comprises a personal computer.

21. The computer program product of claim 10, wherein the client device comprises a cellular phone.

22. A screen management system for playing a media stream on a client device, the screen management system comprising a computer-readable medium containing computer program code for receiving a media stream from a remote source over a network and displaying the received media stream on the client device, the computer-readable medium further containing computer program code for presenting a plurality of graphical elements on a display screen of the client device, the graphical elements comprising:
a media player partition of the display screen for viewing the media stream on the client device, the media player partition including a display area for viewing the media stream and a set of controls for adjusting the media stream received by the client device from the remote source, wherein the media player partition is adjustable on the display screen of the client device; and
an active partition of the display screen for providing a user interface for other programs on the client device, wherein the active partition is configured to adjust according to adjustments made to the media player area.

23. The system of claim 22, wherein the active partition is configured to rescale any content therein in response to any adjustment of the media player partition.

24. The system of claim 22, wherein the media player partition is a sidebar on a side edge of the display screen of the client device.
